(19) United States
(12) Patent Application Publication
(10) Pub. No.: US 2024/0053480 A1
(43) Pub. Date: Feb. 15, 2024

(54) HYBRID DEPTH IMAGING SYSTEM

(71) Applicant: Jabil Optics Germany GmbH, Jena (DE)

(72) Inventor: Ian Blasch, Boise, ID (US)

(73) Assignee: Jabil Optics Germany GmbH, Jena (DE)

(21) Appl. No.: 18/266,867

(22) PCT Filed: Dec. 15, 2020
(86) PCT No.: PCT/EP2020/086129

§ 371 Date: Jun. 13, 2023

(51) Int. Cl. G01S 17/894; G01S 17/86; G01S 7/4865; G06T 7/521

(52) U.S. Cl. CPC G01S 17/894; G01S 17/86; G01S 7/4865; G06T 7/521; G06T 2207/10028

(57) ABSTRACT

The present invention refers to a hybrid depth imaging system for three-dimensional depth imaging of a surrounding of the system, comprising phase imaging and ray imaging techniques for an improved performance. The invention is related to a depth imaging system for imaging a surrounding of the system, comprising an active phase imaging, PI, system for imaging the surrounding in the far field of the system and an ray imaging, RI, system for imaging the surrounding in the near field of the system.

### TECHNICAL FIELD

The present invention refers to a hybrid depth imaging system for three-dimensional (3D) depth imaging of a surrounding of the system, comprising phase imaging (PI) and ray imaging (RI) techniques for an improved performance.

### BACKGROUND

3D depth imaging techniques can be broadly divided in wavefront-based imaging (phase imaging, PI) and ray-based imaging (ray imaging, RI). An actual review over these techniques is given in Chen et al. (Chen, N. et al., “3D Imaging Based on Depth Measurement Technologies”, Sensors 18, 3711 (2018)). Many techniques have been developed in PI, including coherent diffraction imaging, phase retrieval, holography, wavefront-based light field imaging, time-of-flight (ToF), and structured-light. For RI, there are also a lot of techniques such as stereo imaging and (ray-based) light field imaging (stereo imaging can be regarded as an extreme light field imaging).

For 3D imaging systems or sensors which can capture depth data of objects in a surrounding of the system, typically light/laser detection and ranging (LiDAR/LaDAR), time-of-flight (ToF, direct and indirect versions), amplitude or frequency modulated illumination, structured light, etc. are used. Such systems are found in autonomous mobile robots (AMRs), industrial mobile robots (IMRs), and automated guided vehicles (AGVs) like lift trucks, forklifts, cars, drones, etc. to avoid collisions, to detect obstacles, for passenger monitoring and for observing keep-out-zones for machines and robots. These systems can also be used for collaborative robotics, security and surveillance camera applications.

A typical ToF depth sensing system consists of an illumination system (illuminator) including beam forming (e.g. electronic and/or optical beam forming in a temporal and/or spatial manner), an imaging system (imager) comprising a receiving optics (e.g. a single lens or a lens system/objective) and an image detector for image detection, and an evaluation electronics for calculating the distances and maybe setting some alarms from the detected image signal. The illuminator typically sends out modulated or pulsed light. The distance of an object can be calculated from the time-of-flight which the emitted light requires for traveling from the illuminator to the object and back to the imager. Optical beam forming can be achieved by a beam shaping optics included in the illuminator. The beam shaping optics and the receiving optics can be separate optical elements (one-way optics) or the beam shaping optics and the receiving optics can use single, multiple or all components of the corresponding optics commonly (two-way optics).

ToF solutions have several known performance limitations:
1. Inability to see immediately in front of the sensor. A ToF sensor's detection region begins at the crossover of the emitter field of view (FoV) and the receiver FoV, thus creating a blind spot in front of the sensor.
2. Inability to detect objects with low albedo (black objects, polyester materials).
3. Inability to detect objects with high specular reflection (glass bottles, mirrors, windows).
4. Inability to work in high ambient light conditions.
5. Inability to detect objects when the active illumination (VCSELs/LEDs) are turned off.
6. Interference when multiple ToF sensors operate in the same space.

Some ToF solutions based on fisheye-type lenses are also susceptible to straylight noise. As the detector approaches overexposure, straylight can enter non-adjacent pixels leading to inaccurate depth measurements across many regions of the detector.

Improving crossover is possible by aligning the angle of the receiver and the emitter, i.e. by aligning the FoVs of the illuminator and imager with each other such that the blind spot is minimized. However, this comes with downsides such as sensor blooming, straylight, and reduced performance at further distances from the sensor. Another approach to remove or soften said restrictions is to align a plurality of non-interfering individual sensor solutions. However, this will increase cost, complexity, parts, etc. of the sensor system.

A major limitation of active illumination in ToF, structured light, and active stereo solutions it that they fail in high ambient light conditions. Initial solutions used light with a wavelength of 850 nm, but the industry is transitioning to 940 nm to improve performance in daylight conditions. There are also imaging solutions that may enter the market at 1350 nm. However, there are no solutions for improving the ability to view objects with low albedo or high specular reflection while using near infrared (NIR) active illumination.

Some of said limitations of typical ToF sensors do not apply to other 3D depth imaging techniques, in particular to RI techniques in the visible spectral range. Such direct imaging techniques, whether active or passive, can be used with conventional image or video cameras. They do not require any elaborate spectral, spatial or temporal beam shaping. However, for AMR, IMR or AGV applications, these direct 3D depth imaging techniques are not sufficient in terms of performance range, depth accuracy, speed and resolving objects with texture compared to PI techniques such as ToF. Furthermore, RI techniques typically require a considerable additional effort in the evaluation of the images and to combine them into a machine interpretable 3D model of the surrounding.

In stereo imaging, two images of the surrounding are captured with cameras that are spatially separated. Due to the different viewing angle, objects in the foreground and background appear differently offset in the image. In combination with, for example, image recognition techniques or specific model assumptions regarding a scene in the surrounding, the distance of the objects to the imaging system can be calculated. Stereo imaging is a simple technique which can be extended to more than two images. However, as depth information is extracted from offsets within the different images of the same objects in a scene in the surrounding, the images has to be combined and depth information has to be extracted with considerable increasing effort.

With light field imaging techniques stereo imaging is extended to capturing a variety of images of the surrounding at once. However, while in stereoscopic imaging typically the distance between the independent cameras is typically in the range of several centimeters, for light field imaging a single camera with one detector may be used. The variety of images of the surrounding can be achieved by a microlens array (lenslet array) located in front of a detector with high resolution. The individual images of the surrounding focused by the individual lenslets can then be combined to extract depth information from the images.

However, depth imaging is also possible from a single image by recovering a defocus map (Zhuo, S., and Sim, T., “Defocus map estimation from a single image”, Pattern Recognition 44(9), pp. 1852-1858 (2011)). The method uses a simple yet effective approach to estimate the amount of spatially varying defocus blur at edge locations. In an underlying depth from defocus (DFD) model the so-called blur kernel is a symmetric function whose width is proportional to the absolute distance in diopters between the scene point and the focal plane. A symmetric blur kernel implies a two-fold front-back ambiguity in the depth estimates, however. This ambiguity using only a single image can be resolved by introducing an asymmetry into the optics.

Kunnath et al. (Kunnath, N., et al., “Depth from Defocus on a Transmissive Diffraction Mask-based Sensor,” IEEE 17th Conference on Computer and Robot Vision (CRV), pp. 214-221 (2020)) proposed a fast and simple solution which uses a transmissive diffraction mask (TDM), namely a transmissive grating placed directly in front the detector, to introduce such an asymmetry into the optics. The detector they use has a TDM with vertical gratings, i.e. aligned perpendicular to the surface of the image detector. However, horizontal gratings aligned parallel to the surface of the image detector or a combination of vertical and horizontal gratings could also be used for a corresponding TDM. The TDM grating lies on top of a standard CMOS sensor. The grating spans the entire sensor and has a spatial frequency that matches the Nyquist frequency of the sensor, so that one cycle of the grating frequency corresponds to two CMOS pixels. The TDM produces an angle-dependent response in the underlying subpixels which can be used as asymmetry for the blur kernel to extract depth information also from a single image.

In summary, both PI and RI techniques can be used for 3D depth imaging, each with its individual advantages and disadvantages. While PI techniques like ToF are widely used in AMRs, IMRs or AGVs, they have several known performance limitations. On the other hand, for RI techniques like stereo imaging or light field imaging some of these limitations do not apply, but they have their own performance limitations and are thus not always suitable for 3D depth imaging applications in AMRs, IMRs or AGVs.

The objective problem of the invention is thus related to the constant problem of improving the performance of 3D depth imaging systems. In particular, a depth imaging system shall be provided which has the advantages of PI techniques in terms of reliability, accuracy, speed and resolution without suffering from known limitations such as non-detectable objects, their dependency on specific environmental lighting conditions, and/or susceptibility to interference with light from other sensing solutions.

### SUMMARY

The invention solves the objective problem by providing a depth imaging system as defined in claim 1.

A depth imaging system for imaging a surrounding of the system according to the invention comprises an active phase imaging, PI, system for imaging the surrounding in the far field of the system and an ray imaging, RI, system for imaging the surrounding in the near field of the system. The PI system can be a ToF system. The RI system can be a camera system. Both systems can be independent from one another or combined in a common PI-RI system. The combination of PI and RI imaging techniques for depth imaging is referred as hybrid depth imaging. The term near filed is used to describe regions in the vicinity (e.g. up to a couple of meters) of the imaging system. The term far filed is used to describe regions of the environment that are further away (e.g. from a couple of meters up to a few ten meters or further) from the imaging system. The beginning of the far field and the maximum distance that can be imaged (depth-of-field, DOV) can be defined be the specifications of the PI system. The respective depth range of the RI system in the near field can as well be defined by the specifications of the RI system, however, a camera system, for example, may not be limited to allow imaging only in the near field (i.e. the DOV may not be limited to the near field). Instead, the RI system could also be able to image the far field as well as the near field.

In some embodiments, the near field may be defined as the region from the imaging system up to beginning of the far field as defined by the specifications of the PI system. In other embodiments, the near field may be defined by an optimized or limited imaging range of the RI system. The depth information evaluated by an RI system, which also maps the far field of the imaging system in parallel to the PI system, can preferably also be compared with each other to increase the reliability of the depth imaging by verifying the results obtained with the different methods. In particular, the limitations of ToF PI systems can be bypassed with an additional RI system working in parallel and allowing to mutually supplement missing depth or intensity information.

Preferably, the RI system is used for imaging the surrounding up to a first distance d₁ from the imaging system. The first distance d₁ can define the end of the near field. For determined depths values from RI systems, as stated above, various methods can be applied. This determination can be limited to specific depth ranges during image processing. When such a limitation is applied, imaging the surrounding can be limited up to a first distance d₁. Therefore, even when the RI system is in principal able to image the near and far field of the imaging system, the imaging the surrounding can be limited to image only up to the first distance d₁ from the imaging system. The imaging of the surrounding could also be optically limited by the specifications of the RI system, e.g. by an optimization or limitation that only allows near field imaging up to a first distance d₁ from the imaging system. However, the RI system can also be used for imaging the surrounding beyond the first distance d₁ from the imaging system.

Preferably, the PI system comprises an illuminator and an imager, wherein the illuminator is adapted to illuminate in a field of view of the illuminator the surrounding of the system such that illumination light that is reflected by the surrounding can be imaged by the imager in a field of view of the imager as imaging light, wherein the field of view of the illuminator and the field of view of the imager only partially overlap, wherein the overlap starts at a distance d₂ from the imaging system which is equal to or larger than the first distance d₁, wherein the PI system is adapted for imaging the surrounding starting at the second distance d₂ from the imaging system.

In particular, at the second distance d₂ the far field may begin. The beginning of the far field and the maximum distance that can be imaged can be defined be the specifications of the PI system. If the field of view of the illuminator and the field of view of the imager only partially overlap, consequently some regions of the respective fields of view are not overlapping. In an active PI system like ToF the imageable region of the environment is limited to regions which are within both fields of view, i.e. imaging the surrounding is only possible in regions where both fields of view are overlapping. When the field of view of the illuminator and the field of view of the imager are arranged with an offset to one another, then the overlap (crossover) starts at a certain distance from the imaging system. In such an arrangement, the non-imageable nearfield creates a blind spot around the imaging system. However, this is quite intentional, otherwise the image detector can easily be overexposed and saturated by highly intense reflections from nearby objects. Using a PI system in which imaging starts from a certain distance from the imaging system reduces the occurrence of such effects. The beginning of the far field, e.g. at the distance d₂ from the imaging system, and the maximum distance that can be imaged can thus be defined by the specifications of the PI system, in particular by the illumination intensity, the width of the respective fields of view, their overlap or crossover, and a mutual offset between them.

An imager is to be understood as a device which is able to receive, focus and detect imaging light entering the imager from a surrounding of the imager. It therefore typically comprises at least an (preferably ring-shaped circumferential 360 degrees) entrance aperture adjacent to the surrounding, a lens or other optical element to generate an image of the surrounding and an associated image detector to store the generated image of the surrounding for further processing. Since the generation of the image is the far most critical aspect for ensuring a good image quality, instead of using a single lens or optical element, complex lens systems (or optical component systems in general) for the correction of occurring aberrations may be used in an imager. An imager can be a device which uses ambient light for imaging (e.g. visible or infrared light) or is specifically adapted to image reflected light from an external illumination light source (illumination light) as imaging light (e.g. flash LIDAR).

Preferably, an imager including a lens system is further adapted to image around the optical axis of the lens system in an image on an image plane perpendicular to the optical axis of the lens system. However, some components of the lens system may also be arranged off-axial or the image plane could be shifted and/or tilted with respect to the optical axis of the optical system. Such embodiments allow an increased flexibility for matching the FoV of the imaging system to a specific region of interest (ROI) in ToF depth sensing applications.

In a preferred embodiment, the image detector may have an active detection region which is adapted to the image size. As the central region of the image, which can correspond to viewing angles outside the field of view of the imager, may not be relevant for imaging, these regions of the image detector can be completely omitted or suppressed during image readout or by detector mapping. This has the advantage that passive regions of the image detector cannot be saturated or overexposed by accidentally captured ambient or scattered light. Furthermore, due to the fact that no readout of insignificant detector regions has to be performed, the effective frame rates of a specific type of detector can be increased at some detector designs. Through higher frame rates, the accumulation of optically induced charge carriers in the individual pixels of a detector can be reduced such that the SNR of the detector can be optimized for image detection over a wide dynamic range without using other HDR techniques.

An illuminator is to be understood as a device which is able to emit illumination light in a surrounding of the illuminator. In a depth imaging system, an illuminator may provide a bright light impulse, which is reflected by objects in the surrounding and which then can be imaged as imaging light by an associated imager having an image detector (e.g. flash LiDAR). However, an illuminator can also be configured to provide a temporally and/or spectrally well-defined light field which also interacts with objects in the surrounding of the illuminator to be reflected and which can be imaged afterwards (e.g. standard LiDAR or ToF). The term is therefore not restricted to a specific type of light source or a specific type of illumination for the surrounding. The discussed types of depth imaging systems are usually referred to as active imaging systems. In contrast, passive depth imaging systems are designed to use only ambient light for imaging and therefore they do not require an illuminator as an essential component.

Preferably, the RI system comprises an additional camera system configured for imaging independent from the PI system. Such an embodiment has the advantage that the PI system and the RI system are independent from one another and can, for example, replace one another in case of a failure of one of the systems. Another advantage is that standard optical camera systems can be used.

Preferably, the PI system and the RI system are combined to a common detector system. A common detector system enables a more compact design where PI components and RI components can be better matched than when using individual systems. The use of a single lens or lens systems also reduces the possible occurrence of conflicting depth values of both systems caused by optical effects within the imaging systems.

Preferably, the common detector system comprises a microlens array or a diffractive element in front of pixels of a detector of the PI system. A microlens array can be used for light field imaging with the image detector of the PI system. In particular, the diffractive element can be a transmissive diffraction mask (TDM) according to a depth imaging method proposed by Kunnath et al. (Kunnath, N., et al., “Depth from Defocus on a Transmissive Diffraction Mask-based Sensor,” IEEE 17th Conference on Computer and Robot Vision (CRV), pp. 214-221 (2020)). A monochrome image detector can be used in this embodiment.

It is therefore an idea of the invention to provide a depth imaging system with improved performance. In particular, 3D depth imaging system shall be provided which has the advantages of PI techniques in terms of reliability, depth accuracy, speed, and resolution without suffering from known limitations such as non-detectable objects or their dependency on specific ambient light conditions. The known limitations of PI systems and in particular ToF systems are addressed combining the PI system with a RI system.

For example, the RI depth imaging may be performed by an additional camera or further optical elements may be directly integrated in the optical path of the imager of the ToF system. An additional source of depth data is used to complement the resolved PI depth data. The optical elements may use diffraction to measure depth directly through an optical encoder (lens element) optimized for PI with an image depth processing hardware or software block. The diffraction approach is best suited for detection of objects within a near proximity of the imaging system. However, instead of the using diffraction, also a light field approach could be substituted capturing both the intensity of light and the direction of the light rays. In both cases an additional optical element can be directly inserted between an image detector and a lens assembly of an imager of a PI system.

Preferably, the imaging system further comprises a control module configured to individually control the PI system and the RI system based on monitored pixel metrics or an actual and/or prospected motion profile of the system.

The control module may switch between PI and RI based on monitored pixel metrics to select if both, the PI system and the RI system, or just a single system may be active and used for depth imaging the surrounding depending on actual intensity values of individual pixels or pixel areas in one or more consecutive frames. The control module may also be able to adapt the illumination and imaging parameters (e.g. intensity and/or spatial distribution of illumination light, framerate for detector readouts, regions of interest) to actual requirements for an optimized depth imaging of the surrounding.

For example, if the control module detects an impending overexposure or saturation of the image detector caused by PI illumination light, the control module could at least partially reduce the intensity of this illumination light or even temporarily deactivate the active illumination of the PI system. In this case, depth imaging may only be performed with the RI system. An impending overexposure or a saturation of the image detector can occur when the imaging system meets another imaging system emitting PI illumination light with the same wavelength or when the imaging system approaches a wall or another obstacle The reflected illumination can saturate pixels across the detector, not just pixels associated with the illumination light directly facing the obstacle. On the other hand, a passive RI system may be switched off temporarily in poor visibility conditions and especially in the dark to avoid the resulting dark noise of the detector to be considered for further image processing. Further, overexposure and possible saturation of an individual RI image detector by intense light only affecting the RI system can be avoided.

An actual motion profile is to be understood as a combination of all relevant movements the imaging system actually performs. This movements can be defined absolutely (e.g. via GPS) or relatively (e.g. via predefined boundaries for the working area of a robot) and may include traveling in all three axes, a rotation of the system or, for example, tilting, moving or rotating one of the components of a robot (e.g. an arm or gripper temporarily moving in a FoV of the imaging system). Since the control module can use this information, the illumination can be directed or limited to avoid any unnecessary or disadvantageous light emission from the illuminator of the PI system. This may be particularly interesting in cases where a field of view of the PI system temporarily includes a part of a robot or machine which could cause strong light scattering or reflections which could saturate or overexpose the associated image detector. A possible application is collaborative robotics, in which a depth sensor monitors the movements of a robot arm and a human working in the same workspace. Integrating RI and PI solutions increases the quality of the depth data subsequently enhancing safety of the worker. In applications where a robotic gripper is used to select items from a bin or container, the combination of RI and PI can provide higher quality data in cases where product coloring or packaging is difficult to detect using a PI solution.

When the control module uses known or detected information about the surrounding, they can also be used in combination with an actual motion profile. If a FoV includes an object or surface which may cause strong light scattering or reflections which could saturate or overexpose an associated image detector, then the illumination directed towards these obstacles may be redirected, reduced or completely suppressed. For example, during operation, it is very likely that AMR will navigate along walls, shelving, and/or into corners. The proximity to the walls, shelves, or objects increases the likelihood of overexposure. Saturation and overexposure can be prevented, for example, by dimming at least some of the illumination sources in a progressive pattern may be applied.

In contrast to an actual motion profile, a prospected motion profile predicts future movements of the system. This information can be, for example, based on extrapolation from an actual motion profiles or derived from a predefined route or travel path. By using a prospected motion profile for controlling, the system response can be faster and any saturation or overexposure of an associated image detector can be avoided already in advance (predictive saturation avoidance, PSA).

For example, in many mobile robotics applications, the robot is near a wall, object, etc. When an active illumination-based depth sensing solution like ToF is close to an object, a potential risk is created whereby the illumination can either overexpose the detector, create stray light contamination across the detector, or both. Typically solutions are limited to reducing the ToF illumination or completely turning the illumination ‘off’ rendering the robot temporarily blind. With an additional independent depth imaging technology according to the invention, the ToF illumination can be significantly reduced or turned ‘off’, but the robot can still leverage depth data from the additional depth imaging approach for its object detection and collision avoidance algorithms.

When active illumination is reduced or removed, adaptation of the shutter sequencing/algorithm may or may not be required to effectively use the additional depth imaging technology approach. Algorithms in specific ToF implementations may remove the contribution of background light from overall captured light during the shutter opening. The captured light is comprised of both active illumination from the illuminator and background illumination from the environment. When active illumination is removed, the depth algorithm may change accordingly in an inter or intra-frame manner.

Realtime control of the two modes of depth capture may be based on monitoring pixel metrics such as pixel intensity, cluster of pixel intensities, pixel depth values, cluster of pixel depth values, rate of change of depth pixel values, intensity values, etc. Based on these values, real-time control of the ToF illumination and subsequent depth algorithms can be applied to optimize the quality of the depth information sourced from both the ToF system and the additional depth imaging pipelines. In standard operation, depth data may be captured from both the ToF and additional depth approaches. In locations or environments limiting the use of active illumination, the alternative depth imaging technology approach can be used.

Another common problem with PI depth imaging is interference or noise that can be can occur when the active illumination of multiple sensors overlaps. When the illumination uses light of the same wavelength, the respective imagers capture photons from both imaging systems. As the imaging systems are unable to distinguish the difference in the photons, the added photons compromise signal integrity leading to incorrect depth measurements.

This issue can be counteracted by implementing an illumination control architecture using a combination of outside sensor/control data, comparative sensor data, and/or intensity data. In certain implementations, AMRs (or other autonomous devices) can be connected to a global system that tracks the positioning of the AMRs in a factory or material handling environment. As such, data can be sent to the AMR informing the control module of the AMR that another AMR will be entering its FoV. Such embodiments can be subsumed under controlling the depth imaging systems based on an actual and/or prospected motion profile of the system, i.e. the imaging system knows in advance that an approach to a wall, an obstacle, or another AMR is immanent such that appropriate preparations can be made.

An illumination control architecture can also be trained to detect influences from opposing illumination systems. When the respective FOVs overlap, the opposing illumination impacts the depth data in a measurable pattern. Detecting this pattern in a progression of frames can alert the imaging system that illumination from another sensor is in the proximity. When interference from an opposing imaging system is detected, active illumination can be reduced and the sensor defaults to capturing depth data from the alternative depth imaging technology.

Preferably, the imaging system further comprises a depth image processor adapted to derive from an captured image PI depth values by PI depth algorithms, intensity values by image signal algorithms, and RI depth values by RI depth algorithms. The imaging data from PI image detectors (e.g. ToF detectors) and RI image detectors (e.g. light field imaging cameras), or a common detector system of a combined PI-RI system can be evaluated by an image processor to derive the respective depths and the intensity values. In particular, to evaluate the depth values of the PI system, PI depth algorithms can be applied to a PI depth processor (PIDP). For evaluating the depth values of the RI system, RI depth algorithms may be applied a RI depth processor (RIDP). The intensity values can be evaluated with standard techniques by an image signal processor (ISP). The PIDP, the RIPD and the ISP are components of a depth image processor according to the invention.

Both the PI (e.g. ToF) and the RI (e.g. diffraction-based or light field) imaging technology require specific image depth processing hardware or software blocks. For example, a companion ASIC from Analog Devices, can perform ToF depth calculations based on pixel data from a Panasonic ToF system. However, there are many ToF solutions on the market, some use companion chips (e.g. ASIC, DSP, GPU, VPU, FPGA) to perform the depth calculations, and some integrate the functionality in the ToF system itself.

A diffraction-based depth technology software block can be installed on an SD card embedded in the imaging system and executed on an embedded processor. However, the software block could also be executed on a host computer, FPGA, or dedicated ASIC depending on the system architecture of the imaging system and/or the host architecture.

It is well known that ToF solutions can fail to detect certain objects and materials. The use of near infrared light is limited by low albedo materials and surfaces. For example, a watch located on the wrist of a person, may not appear in the depth image when the watch is fabricated from a black material. The use of an RI approach provides an additional depth sensing method capable of detecting these objects and providing depth values also for them. The additional use of RI depth imaging technology thus allows to capture depth data in a scene which include objects or regions which would be normally invisible to a ToF or PI system in general.

Preferably, the illumination from the PI system can be in a radial pattern for 360 degree operation or in a planar pattern for traditional XY operation or employ both modes of illumination patterns simultaneously. Typical implementations of ToF systems output depth information and intensity information. With a hybrid approach according to the invention, the image processor can output depth data from the PI system, intensity information, and depth data form the RI system.

Preferably, the PI system is a ToF system configured to image imaging light in the near infrared (NIR) spectral range. The wavelength of the illumination light can preferably be around 850 nm, 905 nm, 940 nm or 1350 nm. Imaging light with longer wavelengths in the NIR spectral range improves performance in daylight conditions. However, the ability to view objects with low albedo or high specular reflection while using near infrared active illumination is limited.

Therefore, the RI system is configured to image imaging light in a different spectral range, preferably in the visual (VIS) spectral range. Viewing objects with low albedo or high specular reflection may be possible with VIS. However, under poor visibility conditions and especially in the dark, a passive RI system may not be able to sufficiently optically image the surrounding. In such environments, an additional active illumination for the RI system may be required. For such illumination white or colored light in the visual spectral range may be used constantly, pulsed or flashed. Alternatively, illumination light from the PI system may be used accordingly.

In other embodiments, however, the imaging light for the RI system may have the same wavelength as the illumination light for the PI system, for example, around 940 nm. A bandpass filter can be used to limit the wavelength to 940 nm. In an example of these embodiments, the depth imaging system may be configured in such a way that when the PI system is in operation, a VCSEL, LED or other suitable light source can illuminate the surrounding for PI. When the RI system is in operation, the light source of the PI system can be turned off and a 940 nm flood illuminator can flash. Due to the different types of illumination, even though light of the same wavelength is used, the ability to view objects with low albedo or high specular reflection can still be improved by using RI. Therefore, no visible light is required for RI. In the described embodiment, the imaging light can be emitted by two independent sources or a single sources working in two different operational modes for PI and RI illumination. Other preferred wavelengths to be used are 850 nm, 905 nm, or 1350 nm.

Further preferred embodiments of the invention result from features mentioned in the dependent claims.

The various embodiments and aspects of the invention mentioned in this application can be combined with each other to advantage, unless otherwise specified in the particular case.

### BRIEF DESCRIPTION OF THE DRAWINGS

In the following, the invention will be described in further detail by figures. The examples given are adapted to describe the invention. The figures show:

FIG. 1 a schematic illustration of a first exemplarily embodiment of a depth imaging system according to the invention;

FIG. 2 a schematic illustration of a common detector system comprising a microlens array;

FIG. 3 a schematic illustration of a common detector system comprising a diffractive element;

FIG. 4 a schematic illustration of parameters derived by a depth image processor according to the invention; and

FIG. 5 a schematic illustration of a second exemplarily embodiment of a depth imaging system according to the invention.

### DETAILED DESCRIPTION

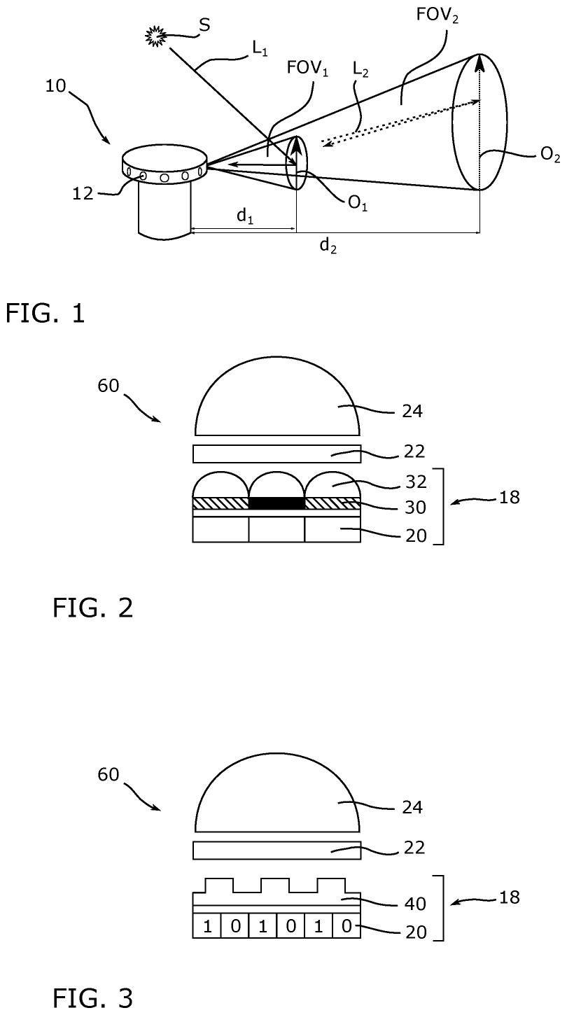

FIG. 1 shows a schematic illustration of a first exemplarily embodiment of a depth imaging system 10 according to the invention. The imaging system 10 may be a radial imaging system configured for imaging an azimuthal angle range of 360° in the horizontal plane. In particular, the imaging system 10 may include a number of individual imaging subsystems arranged around the circumference of a head of the imaging system 10. The entire captured imaging light and any required illumination light is in this embodiment transmitted through individual apertures 12 from and to the surrounding of the imaging system 10. The apertures 12 can each comprise an antireflective coated optical window. The individual imaging subsystems may each include an active PI system 14 and RI system 16 for imaging the surrounding. Preferably, the PI system 14 and RI system 16 corresponding to a common subsystem may use a common detector system 18 for imaging. However, the RI system 16 could also comprises an individual detector for imaging the surrounding independent from the PI system 14. An active PI system 14 can be a ToF system and an individual RI system can be a camera system. In a common detector system 18 a ToF detector may be used also for RI forming an integrated system 14 (hybrid PI-RI system).

The active PI system 14 may be adapted for imaging the surrounding in the far field of the system and the RI system 16 for imaging the surrounding in the near field of the system 10. The RI system 14 can be optimized for imaging the surrounding up to a first distance d₁ from the imaging system 10. The PI system 14 can comprise an illuminator 50 and an imager 60, wherein the illuminator 50 may be adapted to illuminate in a field of view of the illuminator FOV50 the surrounding of the system 10 such that illumination light A that is reflected by the surrounding can be imaged by the imager 60 in a field of view of the imager FOV60 as imaging light B, wherein the field of view of the illuminator FOV50 and the field of view of the imager FOV 60 only partially overlap, wherein the overlap starts at a distance d₂ from the imaging system 10 which is equal to or larger than the first distance d₁, wherein the PI system 14 is adapted for imaging the surrounding starting at the second distance d₂ from the imaging system 10 (for the individual components of a PI system reference is made to FIG. 5).

In this embodiment, an object O₁ next to the imaging system 10 may be illuminated by an external light source S, which can be either a component of the imaging system 10 itself (e.g. LED) or independent from the imaging system 10 (e.g. street light or natural illumination of the surrounding). The corresponding RI illumination light L₁ can be reflected by the object O₁ and imaged by the RI subsystem 16 of the respective imaging subsystem. The RI subsystem 16 has a field of view FOV₁ which may basically be defined by the numeral aperture of the corresponding aperture 12. The maximum distance up to which the RI subsystem 16 can take images is practically limited by the maximum image resolution. Although the RI subsystem 16 may also be capable of reliably depth imaging objects that are further away from the imaging system 10 than a distance d₁, the imaging system 10 may only use the PI subsystem 14 for depth imaging in this range due to its significantly increased performance. A second object O₂ at a greater distance d₂ from the imaging system 10 is in the field of view FOV₂ of the PI subsystem 14 (which is defined by the crossover in the fields of view of the illuminator 50 and the imager 60). The light L₂ which is imaged by the PI subsystem 14 may be first emitted by the illuminator 50 before it is reflected by the second object O₂ and finally imaged by the imager 60. The field of view FOV₁ of the RI subsystem 16 and field of view FOV₂ of the PI subsystem 16 may be pointing in the same direction or field of view FOV₁ of the respective fields of view may only be partly overlapping while pointing in different directions.

However, as one idea of the invention is to avoid blind spots next to the imaging system 10 in the images of the PI system 14, the imaging of the additional RI system 16 can be optimized for imaging up to the distance where the field of view of the illuminator FOV50 and the field of view of the imager FOV60 of the PI system 14 begin to overlap. The RI system 16 can thus be used for near field imaging (e.g. up to a few meters) while the PI system 14 is used for imaging the far field (e.g. from a few meters up to a few ten meters or further) of the imaging system 10.

In particular, ToF systems measure the time required for light to leave an emitter, reflect off an object and return to a receiver. The emitter's light is projected in a defined FoV and is detected if it overlaps in the FoV of the receiver. The theoretical detection range is defined by the overlap of these two FoVs. In the distance (far field), distance can be measured with the ToF system (indirect or direct ToF). The distance where the far field begins may be defined as the nearest crossover point between the FoV of the emitter and the FoV of the receiver. Objects located in the near field (before the far field) are not detected as they are located outside of the overlapping FoVs. This inherent blind spot can be compensated, with a hybrid approach according to the invention and in particular when light field imaging or diffractive filters are directly integrated into a single lens solution of the ToF system. The diffraction-based depth imaging technology is therefore capable of detecting objects located in the near field and the ToF solution is capable of detecting objects in the far field.

FIG. 2 shows a schematic illustration of a common detector system 18 with a microlens array 32. Additionally shown for illustration purposes are an imaging lens 24 and an optional optical filter 22 between the imaging lens 24 and the common detector system 18. The optical filter can be, for example, a polarization filter and/or a spectral filter. Instead of a single imaging lens 24, a complex lens system or imaging optics can be used. The lens 24 or lens system in combination with the common detector system 18 may form an imager 60 of an imaging system 10. The illustration shows a possible realization of an integration of light field imaging techniques to a detector of an imager of a PI (sub)system 14. A microlens array 32 with different lenslets is used in front of the pixels 20 of an image detector. However, each lenslet may illuminate more than one pixel 20. In particular, a large number of pixels 20 may be associated with each lenslet of the microlens array 32, wherein for each lenslet a sub-image of the surrounding is captured. Additional color filters 30 may be applied between the microlens array 32 and the pixels 20 of the image detector. The individual sub-images of the surrounding may thus be spectrally separated (spectral imaging).

FIG. 3 shows a schematic illustration of a common detector system 18 with a diffractive element 40. The illustration widely corresponds to the common detector system 18 shown in FIG. 2, to which reference is hereby made. Instead of a microlens array 32, in this embodiment a diffractive element as transmissive diffraction mask (TDM) according to a depth imaging method proposed by Kunnath et al. (Kunnath, N., et al., “Depth from Defocus on a Transmissive Diffraction Mask-based Sensor,” IEEE 17th Conference on Computer and Robot Vision (CRV), pp. 214-221 (2020)) is applied at the same position in front of the pixels 20 of the image detector. A monochrome image detector may be used in this embodiment.

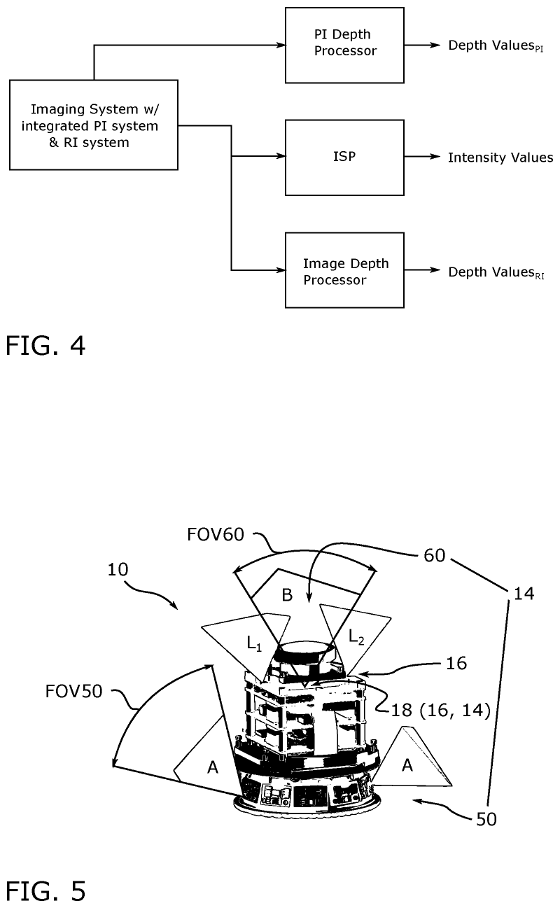

FIG. 4 shows a schematic illustration of parameters derived by an image processor according to the invention. The imaging data from individual PI (e.g. ToF) and RI (e.g. light field imaging) detectors or a common detector system 18 of a combined PI-RI system 14, 16 can be evaluated by an image processor to give the respective depths and the intensity values. In particular, to evaluate the depth values of the PI system, PI depth algorithms can be applied to a PI depth processor (PIDP). For evaluating the depth values of the RI system, RI depth algorithms may be applied a RI depth processor (RIDP). The intensity values can be evaluated with standard techniques by an image signal processor (ISP). The PIDP, the RIPD and the ISP are components of a depth image processor according to the invention.

FIG. 5 shows schematic illustration of a second exemplarily embodiment of a depth imaging system 10 according to the invention. The shown imaging system 10 comprises an imager 60 with a single fisheye-type lens system arranged in an upright position. With such lens systems a radial field of view can be imaged by a single image detector of the imager 60. The lens system defines the field of view FOV60 of the imager 60. The imaging system 10 further comprises an illuminator 50 as integral component of a PI system 14, e.g. a ToF system. The illuminator 50 illuminates the surrounding in a field of view FOV 50 of the illuminator 50 with illumination light A. Furthermore, the imaging system 10 comprises a RI system 16. The RI system may include individual optical cameras which can be located around the central lens of the imager 50. These cameras may be adapted to capture depth data of objects in the surrounding independent from the imager 60.

However, in the case of a common detector system 18, the RI system 16 may be fully integrated within the imager 60. In poor visibility conditions and especially in the dark, a passive RI system 16 may not be able to sufficiently optically image the surrounding. In such environments, an additional active illumination for the RI system 16 may be required. For such illumination white or colored light in the visual spectral range may be used constantly, pulsed or flashed. Alternatively, illumination light from the PI system may be used accordingly. The illumination light L₁ of the RI system 16 can also be reflected by objects in the surrounding before it is imaged by the common detector system 18 together with reflected illimitation light A of the PI system 14.

The imaging light for the RI system 16 may be visible or infrared light with wavelengths different from the wavelengths used for the illumination light A of the PI system 14. The depth imaging system 10 thus comprises an active PI system 14 for imaging the surrounding in the far field of the system and an RI system 16 for imaging the surrounding in the near field of the system 10.

### REFERENCE LIST

10 imaging system
12 apertures
14 phase imaging (PI) system
16 ray imaging (RI) system
18 common detector system
20 pixels
22 optical filter
24 imaging lens
30 color filter array
32 microlens array
40 diffractive element (e.g. transmissive diffraction mask (TDM))
50 illuminator
60 imager
S external light source
d₁, d₂ first and second distance
L₁, L₂ PI and RI light (illumination/imaging)
O₁, O₂ first and second object
FOV₁, FOV₂ PI and RI field of view
FOV50 field of view of the illuminator
FOV60 field of view of the imager
A illumination light
B imaging light

1. A depth imaging system for imaging a surrounding of the system, comprising:
an active phase imaging (PI) system for imaging the surrounding in the far field of the system; and
an ray imaging (RI) system for imaging the surrounding in the near field of the system.

2. The depth imaging system according to claim 1, wherein the RI system is used for imaging the surrounding up to a first distance d₁ from the imaging system.

3. The depth imaging system according to claim 2, wherein the PI system comprises an illuminator and an imager, wherein the illuminator is adapted to illuminate in a field of view of the illuminator the surrounding of the system such that illumination light that is reflected by the surrounding can be imaged by the imager in a field of view of the imager as imaging light, wherein the field of view of the illuminator and the field of view of the imager only partially overlap, wherein the overlap starts at a distance d₂ from the imaging system which is equal to or larger than the first distance d₁, wherein the PI system is adapted for imaging the surrounding starting at the second distance d₂ from the imaging system.

4. The depth imaging system according to claim 1, wherein the RI system comprises an additional camera system configured for imaging independent from the PI system.

5. The depth imaging system according to claim 1, wherein the PI system and the RI system are combined to a common detector system.

6. The depth imaging system according to claim 5, wherein the common detector system comprises a microlens array or a diffractive element in front of pixels of a detector of the PI system.

7. The depth imaging system according to claim 1, further comprising a control module configured to individually control the PI system and the RI system based on monitored pixel metrics.

8. The depth imaging system according to claim 1, further comprising a depth image processor adapted to derive from an captured image PI depth values by PI depth algorithms, intensity values by image signal algorithms, and RI depth values by RI depth algorithms.

9. The depth imaging system according to claim 1, wherein the PI system is a time of flight (ToF) system configured to image imaging light in the near infrared spectral range.

10. The depth imaging system according to claim 1, wherein the RI system is configured to image imaging light in the visual spectral range.

11. The depth imaging system according to claim 1, wherein the imaging light for the RI system may have the same wavelength as the illumination light for the PI system.

12. The depth imaging system according to claim 1, further comprising a control module configured to individually control the PI system and the RI system based on an actual or prospected motion profile of the system.
